(19) United States
(12) Patent Application Publication
(10) Pub. No.: US 2022/0003869 A1
(43) Pub. Date: Jan. 6, 2022

(54) SENSOR DEVICE AND ALIGNMENT METHOD

(71) Applicant: SICK AG, Waldkirch (DE)

(72) Inventors: Gregor HUBER, Waldkirch (DE); Thomas DOLLMANN, Waldkirch (DE)

(21) Appl. No.: 17/305,131

(22) Filed: Jun. 30, 2021

(30) Foreign Application Priority Data
Jul. 2, 2020 (DE) 10 2020 117 428.4

(51) Int. Cl. G01S 17/42; G01S 17/86; G01S 7/481

(52) U.S. Cl. CPC G01S 17/42; G01S 7/4817; G01S 17/86

(57) ABSTRACT

A sensor device (10) comprising a housing (48a-b), a position sensor (44) for determining an alignment, a display unit (46a-d) for displaying alignment information, and a control and evaluation unit (40) configured to use the position sensor (44) to determine the sensor device's (10) alignment, to compare the alignment with a desired alignment, and to display a comparison result using the display unit (46a-d), wherein the display unit (46a-d) comprises at least three light sources (46a-d) at positions distributed over the housing (48a-b), each light source (46a-d) being configured to assume a first display state for a correct alignment and a second display state for an alignment that is not yet correct, with the control and evaluation unit (40) further being configured to display the comparison result as display states of the light sources (46a-d).

The invention relates to a sensor device and an alignment method for a sensor.

A laser scanner is a type of sensor that is challenging to align in practice. In a laser scanner, a light beam generated by a laser periodically sweeps over a monitoring area with the help of a deflection unit. The light is remitted by objects in the monitoring area and evaluated in the scanner. The angular position of the deflection unit is used to infer the angular position of the object, and the distance of the object from the laser scanner is determined by measuring the light time of flight in a phase or pulse method using the speed of light. The angle and distance information describes the location of an object in the monitoring area in two-dimensional polar coordinates. Thus, the positions of objects or their contours can be determined. The scanning movement is generated by a rotating mirror or a polygon mirror wheel, or the entire measuring head including light transmitter and light receiver may rotate instead. While most known laser scanners use a single scanning beam and accordingly detect only one central scanning plane, there are also efforts towards a multi-layer scanner using a plurality of scanning beams.

Laser scanners are also used in safety technology to monitor a source of danger, such as a dangerous machine. A safety laser scanner of this type is known from DE 43 40 756 A1. A protective field is monitored that operating personnel is forbidden to enter during operation of the machine. If the laser scanner detects an inadmissible intrusion into the protective field, such as a leg of an operator, it triggers an emergency stop of the machine. Sensors used in safety technology must operate with particular reliability and therefore meet high safety requirements, for example the EN13849 standard for machine safety and the EN61496 device standard for electro-sensitive protective equipment (ESPE).

The correct position and orientation of a sensor in space is regularly a basic requirement for its application. Accurate alignment usually yields better results, and flexible and accurate alignment allows better adaptation to the specific conditions of an application situation.

Through its distance measurement, a laser scanner can precisely determine its position in the three spatial dimensions with little effort. For the alignment, however, i.e. the orientation in absolute coordinates or with respect to a reference, this cannot be solved so easily. Angular accuracies below 1° are often required. Even if a spirit level is available, it is often not possible to achieve the angular accuracy, or not with a required maximal error, because there are no suitable supporting flat surfaces. It should be noted that it is not necessarily the sensor housing that needs to be aligned, but possibly a reference that is not even visible, such as the scanning plane of the laser scanner. In addition, there are situations where the desired alignment is not horizontal.

It is known to integrate a position sensor into electronic devices such as smartphones, and also specifically into laser scanners, the position sensor measuring the orientation with respect to the gravitational field. In the case of a smartphone, displaying this information on the integrated display is easy. A laser scanner does not have a comparable display and would therefore have to be connected to a configuration system, such as a notebook or tablet. In addition, the position sensors are not initially calibrated: There is no known relation between the orientation of the position sensor and the orientation of the laser scanner. This is even more true with respect to a reference such as the scanning plane, which does not even relate to a physical component. Thus, the position sensor does not provide sufficient assistance for the alignment at the location of the application.

DE 10 2006 053 359 B4 discloses a light grid, wherein a tilt sensor helps to vertically align its two opposing housings. The corresponding display is based on the bubble of a spirit level. Light grids require a rather specific alignment, and the concept is not easily transferable to other sensors. An electronic bubble is not too intuitive in those cases, in particular when it comes to aligning multiple angles in space.

DE 20 2011 053 212 B3 discloses a laser scanner with a rotation rate sensor, which is, however, used for the compensation of imbalances of the scanning movement. DE 10 2013 104 239 B3 is an extension to include a direction deviating from the axis of rotation as well as superimposed translational movements. In DE 10 2013 110 581 B4, an inertial measurement unit is used to superimpose the centers of the scans that change during a movement of the laser scanner.

EP 1 669 776 A1 describes a handheld device with a laser rangefinder whose respective position and orientation are measured by an inertial sensor. Thus, the orientation is known in order to take this into account in the measured value acquisition, but no specific alignment is set, which in any case would be impractical for a handheld device.

In EP 3 176 606 B1, a laser scanner is aligned, but this is done using a reference target rather than an integrated position sensor. EP 2 937 715 B1 enables defining the origin for the scan angle, i.e. the angle periodically changed by the scan movement, by placing a marker on the front screen at the desired zero angle. However, this is not an orientation, and the laser scanner does not know its orientation at all due to the lack of a position sensor.

In the field of autonomous driving, it is common practice to equip the vehicle with a variety of sensors, including laser scanners and inertial measurement units. One example of this is U.S. Pat. No. 8,310,653 B2. The inertial measurement unit is not part of the laser scanner, nor is it used for its alignment.

DE 10 2019 110 803 B3 describes a safety laser scanner that uses a tilt sensor to determine and output its own tilt. However, this is not used for alignment, but rather to detect manipulation if the safety laser scanner has been moved from its intended horizontal position during operation.

Leuze and Pepperl+Fuchs each offer a laser scanner with integrated electronic spirit level under the product name RSL440 and R2000, respectively. In both cases, however, a display on the laser scanner is used.

It is therefore an object of the invention to improve the alignment of a sensor. The term alignment in particular refers to the orientation of the sensor in up to three rotational degrees of freedom.

This object is satisfied by a sensor device comprising a housing, a position sensor for determining an alignment, a display unit for displaying alignment information, and a control and evaluation unit configured to use the position sensor to determine the sensor device's alignment, to compare the alignment with a desired alignment, and to display a comparison result using the display unit, wherein the display unit comprises at least three light sources at positions distributed over the housing, each light source being configured to assume a first display state for a correct alignment and a second display state for an alignment that is not yet correct, with the control and evaluation unit further being configured to display the comparison result as display states of the light sources.

The object is also satisfied by an alignment method for a sensor, wherein an actual alignment of the sensor is determined by means of a position sensor, the actual alignment is compared with a desired alignment, and a comparison result is displayed, wherein the comparison result is displayed by three light sources arranged at positions distributed over the sensor, each of the light sources assuming a first display state for a correct position or a second display state for an alignment that is not yet correct.

The sensor device, or in short the sensor, is preferably configured as a laser scanner or a radar, and it is accommodated in a housing. Throughout this specification, the terms preferably or preferred refer to advantageous, but completely optional features. A position sensor, for example configured as an IMU (Inertial Measurement Unit) and acting as a kind of electronic spirit level, measures its orientation with respect to the gravitational field. This preferably is measured for both angles with respect to a horizontal plane, i.e. roll angle and pitch angle, or in a simpler embodiment for only one of these angles. The yaw angle cannot be measured against gravity and preferably is calibrated, for example, by convention as in EP 2 937 715 B1.

A control and evaluation unit uses the position sensor to determine the sensor device's own orientation and compares the actual orientation thus measured with a desired orientation or target orientation. A resulting comparison result is shown on a display unit. A user can see whether the alignment corresponds to the desired alignment and how, if necessary, the desired alignment can be achieved.

The invention starts from the basic idea of using a simple display unit comprising or consisting of a few light sources. For this purpose, at least three light sources are provided at positions distributed over the housing in the manner of a tripod. The light sources can assume at least two display states, one representing a correct alignment and another representing an alignment that is not yet correct. The light sources are brought into display states according to the comparison between the actual alignment and the desired alignment, which together display the comparison result.

The invention has the advantage of greatly simplifying on-site alignment of the sensor device during setup. The installer can immediately see the correct alignment or orientation without additional equipment or measurement, and adapt it if necessary. The display unit is very inexpensive and undemanding, yet intuitive to grasp. It can even still provide immediate assistance, easily understood by even an untrained installer, as to which correction should be made.

The display states preferably relate to an axis represented by the position of the displaying light source. The display state of the light source thus has a direct local reference to the comparison result. The installer or service technician immediately recognizes in which axis the desired alignment has been achieved and where and in which axis it is still necessary to readjust. Preferably, the light source itself is located on the represented axis, but an offset is also conceivable, which can then preferably be seen intuitively.

The light sources preferably are configured to assume three display states, wherein the control and evaluation unit is configured to display, at a light source, the second display state when the alignment is too low and a third display state when the alignment is too high. A light source thus not only indicates in binary form whether a related part of the alignment is correct. If the alignment is not yet correct, even a direction is indicated in which the desired alignment can be achieved. This makes it much easier to make a correction. It would be conceivable not to understand the second and third display state as a discrete information, but to add an intensity information, which conveys how large the deviation still is. For example, the light source shines brighter, flashes faster or displays transition colors, such as orange for slightly misaligned and red for strongly misaligned.

The light sources preferably are configured to assume display states as different colors. For example, green light corresponds to the first display state, blue light to the second display state, and red light to the third display state. These specifically mentioned colors are, of course, just an example, the user merely needs to be informed of any color's meaning. Switching off a light source can also be interpreted as a display state and, in particular, as a color. In addition or alternatively, flashing sequences can be used, or a light source comprises a plurality of light points that form light patterns. This can also be combined. For example, rapid red flashing means that the alignment is still clearly too high, and when a readjustment is made, the flashing slows down and finally changes to continuous green light when the desired alignment is reached.

The light sources preferably are configured as multicolor LEDs. This is a particularly simple and cost-effective embodiment that enables various display states.

The housing preferably comprises a quadrangular cross-sectional area, and the light sources are arranged in corners, in particular four light sources in all four corners. The cross-sectional area may vary across the housing, reference is made to an area at a height of the light sources. Also, it is a rough basic shape that for example still allows for rounded corners or edges. The analogous arrangement with light sources at 90° intervals is also advantageous for a circular or elliptical shape.

The sensor device preferably comprises an interface for specifying the desired alignment. This can be a wired or wireless interface for connecting a configuration device, or merely a control element on the housing. A horizontal orientation is preferably assumed as the basic setting or default setting, but it is possible to specifically deviate from a basic setting via the interface.

The sensor device preferably is configured as a laser scanner having at least one scanning plane and at least one light transmitter for transmitting transmitted light, a movable deflection unit for periodically deflecting the transmitted light, and a light receiver for receiving remitted light remitted by objects in the scanning plane, the control and evaluation unit being configured to measure distances on the basis of a light time of flight of the transmitted light and the remitted light. Any known time-of-flight method is possible, such as a pulse time-of-flight method, a phase method, or a pulse averaging method. As mentioned above, the periodic deflection can be performed with the aid of a rotating mirror or by rotating a measuring head including light transmitter and light receiver.

The laser scanner preferably is configured as a multi-plane or multi-layer scanner, wherein the transmitted light forms a plurality of scanning beams separated from one another and the light receiver receives the remitted light as a plurality of scanning beams separated from one another. Scanning beams are not to be understood as beams in the sense of beam optics within a larger light beam, but rather as light beams separated from one another and thus isolated scanning beams that generate corresponding isolated, spaced-apart light spots in the monitoring area when they impinge on an object. Thus, each scanning beam scans one of a plurality of scanning planes.

The position sensor preferably is calibrated with respect to a scanning plane. This calibration preferably is performed at the factory when the laser scanner is manufactured. The position sensor in this embodiment is not calibrated to the housing, but to the scanning plane that is relevant to the acquisition function of the laser scanner. While typically the scanning plane is aligned to the housing, there are certain tolerances. For a laser scanner with only one scanning plane, this single scanning plane is of course the reference. For a multi-layer scanner, a central plane at elevation 0° preferably is used.

In the alignment method according to the invention, an actual alignment of the sensor is determined using the position sensor, is compared with a desired alignment, and a comparison result is displayed. The comparison result is displayed by three light sources arranged at positions distributed over the sensor, each of which assumes a first display state for a correct position or a second display state for an alignment that is not yet correct. The sensor in particular is an embodiment of the sensor device according to the invention. Thus, the sensor preferably comprises a housing, the position sensor, a display unit having the light sources, and a control and evaluation unit configured to execute the method steps.

The sensor preferably is configured as a laser scanner having at least one scanning plane that is periodically scanned by a scanning beam, wherein the position sensor is calibrated in advance, preferably already at the factory, with respect to the scanning plane by guiding the scanning beam to a cooperative target and taking an image of the target, in particular using an infrared (IR) camera, and evaluating the image to determine the alignment of the scanning plane. In order to be able to calibrate the sensor in this way, the camera, or the laser line of the scanning plane visible in the camera image, should also be calibrated with respect to the image of the sensor and earth's gravitational field. On site in the field, the scanning plane cannot be seen without auxiliary means. In the factory, however, the usually infrared light of the scanning beam can be made visible, and this is used to calibrate the position sensor with respect to the scanning plane.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

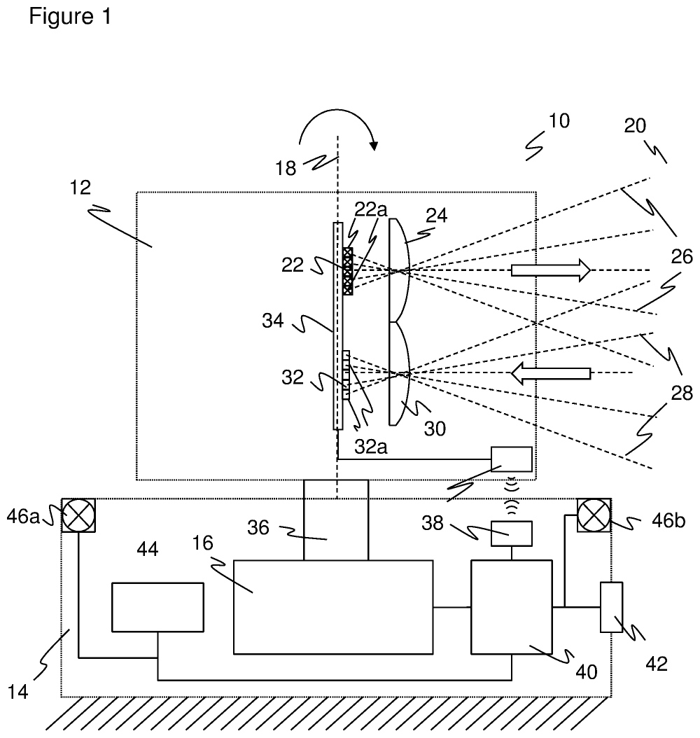

FIG. 1 a sectional view of a laser scanner;

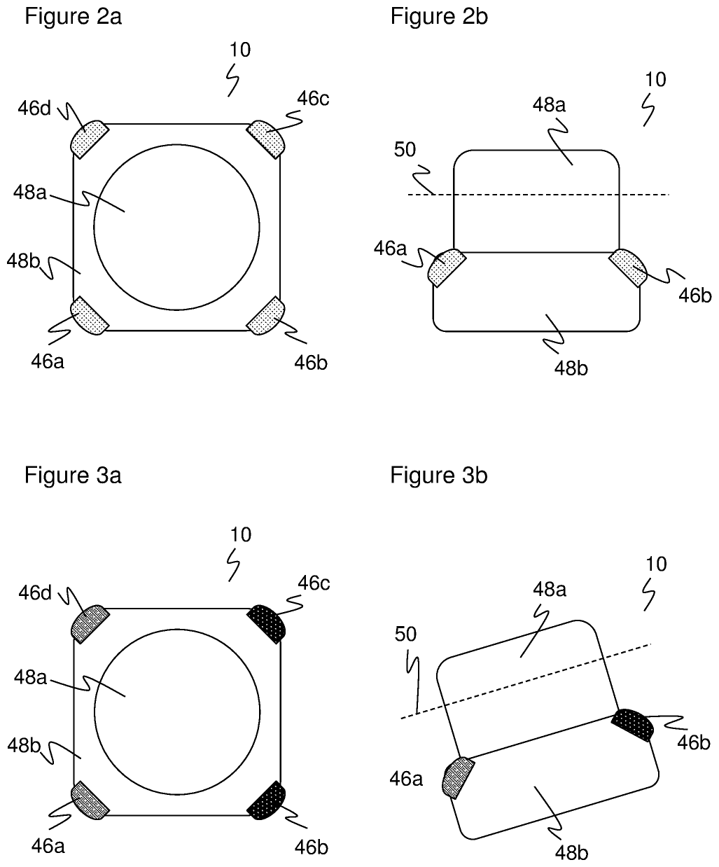

FIG. 2a-b a schematic representation of a laser scanner in a desired alignment and with corresponding indication of the correct alignment by several LEDs as a top view or front view;

FIG. 3a-b a schematic representation according to FIG. 2a-b with a tilt, in this example about a roll angle; and

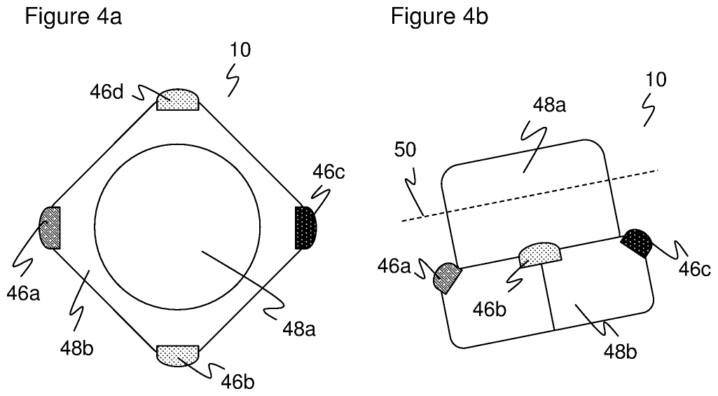

FIG. 4a-b a schematic representation corresponding to FIG. 2a-b with another tilt, now about both roll angle and pitch angle.

FIG. 1 shows a schematic sectional view of an optoelectronic sensor 10 in an embodiment as a multi-layer laser scanner. The alignment according to the invention is particularly advantageous for that kind of laser scanner. However, it is also suitable for a laser scanner having only one scanning plane. Other optoelectronic sensors that operate without periodic scanning motion are also conceivable. Non-optical sensors are possible, in particular a radar whose mode of operation is similar to a laser scanner, in a different range of the electromagnetic spectrum.

The sensor 10 comprises, in a rough description, a movable deflection unit 12 and a base unit 14. The deflection unit 12 is an optical measuring head, while the base unit 14 accommodates further elements such as a supply, evaluation electronics, connections, and the like. During operation, a drive 16 of the base unit 14 causes the deflection unit 12 to move about an axis of rotation 18 in order to periodically scan a monitoring area 20.

In the deflection unit 12, a light transmitter 22 having a plurality of light sources 22a, for example LEDs or lasers in the form of edge emitters or VCSELs, generates a plurality of transmitted light beams 26 using a common transmitter optics 24, and the transmitted light beams 26 are transmitted into the monitoring area 20. In the example shown, there are five transmitted light beams 26 for five scanning planes; there may be more, including significantly more, and there may be fewer transmitted light beams 26. Individual optics are possible instead of a common transmitting optics 24. The plurality of transmitted light beams 26 may also be formed by splitting the light from one or more light sources using a beam splitting element, a diffractive optical element, or the like. In a further embodiment, illumination is provided over a wide area or with a line of light, and the transmitted light is divided into scanning beams at the receiving end.

When the transmitted light beams 26 impinge on an object in the monitoring area 20, corresponding remitted light beams 28 return to the sensor 10. The remitted light beams 28 are guided by a common receiving optics 30 to a light receiver 32 having a plurality of light receiving elements 32a, each of which generates an electrical received signal. The light receiving elements 32a may be separate components or pixels of an integrated matrix array, for example photodiodes, APDs (avalanche diodes) or SPADs (single photon avalanche diodes). The remarks on the transmitting side apply to the receiving side mutatis mutandis. A plurality individual optics may be provided, and a plurality of scanning beams may be detected on a common light-receiving element.

In this embodiment, light transmitter 22 and light receiver 32 are arranged together on a circuit board 34, which lies on the axis of rotation 18 and is connected to the shaft 36 of the drive 16. This is to be understood only as an example, virtually any number and arrangement of circuit boards are conceivable. The basic optical design with light transmitter 22 and light receiver 32 in a biaxial arrangement side by side is optional and can be replaced by any design known per se from single-beam optoelectronic sensors or laser scanners. An example is a coaxial arrangement with or without beam splitter.

A contactless supply and data interface 38 connects the movable deflection unit 12 to the stationary base unit 14, where a control and evaluation unit 40 is located. The control and evaluation unit can also be accommodated at least partially on the circuit board 34 or at another location in the deflection unit 12. In particular, it is conceivable to accommodate part of the evaluation already in the light receiver 32, for example by means of an ASIC design (Application-Specific Integrated Circuit), with individual cells directly performing evaluation and other processing. The control and evaluation unit 40 controls the light transmitter 22 and receives the received signals from the light receiver 32 for further evaluation. It also controls the drive 16 and receives the signal from an angle measuring unit, not shown, that is generally known from laser scanners and that determines the respective angular position of the deflection unit 12.

For evaluation, the distance to a scanned object is measured. Together with the information about the angular position from the angle measuring unit, two-dimensional polar coordinates of all object points in a scanning plane are available after each scanning period in the form of angle and distance. The respective scanning plane, if there is a plurality of scanning planes, is also known via the identity of the respective scanning beam 26, 28, so that a three-dimensional spatial area is scanned in total.

This means that the object positions or object contours are known and can be output via a sensor interface 42. Conversely, the sensor interface 42 or a further connection, not shown, may be used as a parameterization interface. The sensor 10 can also be configured as a safety sensor for use in safety applications for monitoring a source of danger, as briefly explained in the introduction.

The sensor 10 shown in FIG. 1 is a laser scanner having a rotating measuring head, namely the deflection unit 12. Alternatively, a periodic deflection by means of a rotating mirror or a facetted mirror wheel is also conceivable. Another alternative embodiment pivots the deflection unit 12 back and forth, either instead of the rotary motion or additionally about a second axis perpendicular to the rotary motion, in order to generate an additional scanning motion in elevation. Furthermore, the scanning motion to generate the scanning plane may instead be generated using other known methods, such as MEMS mirrors, optical phased arrays, or acousto-optic modulators.

During the movement of the deflection unit 12, a plane is scanned per each of the transmitted light beams 26. Only at a deflection angle of 0°, the middle one of the transmitted light beams 26 shown in FIG. 1, is an actual scanning plane of the monitored area 20 scanned. The other transmitted light beams 26 scan the lateral surface of a cone, which has a different cone angle depending on the deflection angle. If a plurality of transmitted light beams 26 are deflected upwards and downwards at different angles, a kind of nesting of several hourglasses is created as a scanning structure. These surfaces are also referred to as scanning planes for simplicity.

In a practical application, the sensor 10 must be mounted with correct alignment or orientation. To that end, a position sensor 44 is provided, which can be configured as an IMU (Inertial Measurement Unit). The respective alignment information of the position sensor 44 is read in by the control and evaluation unit 40. At least three light sources 46a-b or LEDs are distributed over the sensor 10, where only two of the light sources 46a-b can be seen in the sectional view of FIG. 1. The light sources 46a-b preferably are as far apart as possible and arranged in a common plane. They are controlled by the control and evaluation unit 40 to indicate whether a desired alignment has been achieved or what deviation exists between the actual alignment according to the position sensor 44 and the desired alignment.

FIGS. 2a-b show the sensor 10 in a schematic view without its individual elements, where FIG. 2a is a top view and FIG. 2b is a front view. Only a housing with an upper housing part 48a and a lower housing part 48b as well as the light sources 46a-d are shown. The two housing portions 48a-b may correspond to the deflection unit 12 and the base unit 14, but there may also be a transition region where this correspondence does not apply. The upper housing part 48a is at least partially transparent to allow the scanning beams 26, 28 to pass through, and is also referred to as a hood or front window. In FIG. 2b, the single or central scanning plane 50 at elevation 0° is shown with a dashed line for illustration.

In this embodiment, four light sources 46a-d instead of the minimum number of three light sources are used. They are located at the corners of the square or rectangular cross-section at the top of the lower housing part 48b and thus at the greatest possible distance from each other and in a same plane.

In FIGS. 2a-b, the desired alignment is a horizontal orientation of the scanning plane 50 and thus an upright position of the sensor 10. This can also be expressed in that the pitch and roll angles should be 0°. Both can be measured by the position sensor 44 with respect to the direction of gravity, but the yaw angle cannot be measured in this orientation of the sensor 10. The yaw angle corresponds to the respective angle of rotation of the deflection unit 12, and its origin can be specified independent of the orientation of the sensor 10 in the field or, for example, can be specified by the user as in EP 2 937 715 B1 mentioned in the introduction. As an alternative to the horizontal plane as the desired alignment, a different roll and pitch angle can be specified via the sensor interface 42 or an optional control element (not shown). With an inclined orientation, the angles that can be measured by the position sensor 44 change and, in particular, the yaw angle can also be measured and displayed.

The light sources 46a-d can be controlled by the control and evaluation unit 40 with distinguishable light signals. Preferably, the light sources 46a-d are multicolor, in particular multicolor or RGB LEDs. The display of the alignment is described using different colors as an example. This is a particularly intuitive and easily understood display option. However, a different brightness or sequence of a flashing signal would also be conceivable. Multiple display modalities can also be combined, for example in that rapid flashing in a particular color signifies a strong deviation in a direction coded by the color. The different signals of the light sources 46a-d are used as a display.

The sensor 10 can be set to a corresponding alignment mode for alignment, which is started via the sensor interface 42 or a button on the sensor 10. Outside the alignment mode, the light sources 46a-d preferably are inactive or used for other purposes. For an alignment, the control and evaluation unit 40 performs a comparison, for example cyclically repeated, between the actual alignment detected by the position sensor 44 and the desired alignment that is fixed or specified by the user. At the light sources 46a-d, the control and evaluation unit 40 provides light signals as to whether or not the desired alignment has been achieved on the corresponding axis. Advantageously, the indication for an alignment that is not correct is further differentiated according to the direction. In a specific example, a green indication represents a correct alignment, blue represents too low, and red represents too high. These specific colors can be changed as long as the user knows the meaning. For finer gradations, additional modalities such as brightness can be added to represent the extent of the deviation.

In the example of FIG. 2a-b, the sensor already is correctly aligned in a horizontal plane. All four light sources 46a-d therefore display the same color, for example green, which represents correct alignment.

FIGS. 3a-b show another example where the sensor 10 is tilted in roll angle. The definition of roll angle is a convention, chosen in this case so that the roll angle is measured in one vertical plane of symmetry and the pitch angle is measured in the other vertical plane of symmetry. The light sources 46a,d on the left side light up blue, those on the right side light up red, and it is thus indicated that the sensor 10 needs to be raised on the left relative to the right, or conversely lowered on the right relative to the left.

FIG. 4a-b show another example where the sensor 10 now is tilted in roll angle and pitch angle. Note that in FIG. 4b, the illustration is rotated 90° out of the drawing plane compared to FIGS. 2b and 3b. Since the sensor 10 in this example is tilted with respect to the diagonal to the base plane, the light sources 46b,d show green, since on this axis the alignment is already correct. On the opposite diagonal, corrections need to be made by raising the sensor on the left relative to the right or, conversely, lowering the sensor on the right relative to the left. Thus, in this specific example, roll and pitch angles can be corrected at the same time. In general, the sensor 10 would have different roll and pitch angles, and for this purpose the light sources 46b,d would also light up red and blue, respectively.

Depending on the shape and size of the sensor 10, the positions and number of light sources 46a-d can be varied, as long as there are more than three light sources that are not arranged collinearly and thus define a plane in space. The display can also be acoustically supported.

The position sensor 44 is preferably calibrated when shipped from the factory. The calibration does not necessarily have to be performed with reference to a surface of the housing 48a-b. For a laser scanner, the scanning plane is often the better reference since this is where the measured values are acquired. Due to tolerances, it is not guaranteed that the scanning plane is parallel to a housing surface.

Calibration can be accomplished, for example, by first calibrating the position sensor 44 to one or more known orientations of the laser scanner during manufacturing. The scanning plane is then measured with respect to one of these orientations. One practical way to do this is to place a white target in the scanning plane and, while the laser scanner is scanning, capture an image of that target with an IR camera. In the camera image, the laser scan line can be seen on the target, and image processing algorithms can be used to determine its position as an angle. This can be used to calculate a correction value that references the measurement data from the position sensor 44 to the scanning plane rather than to the housing 48a-b.

1. A sensor device (10) comprising a housing (48a-b), a position sensor (44) for determining an alignment, a display unit (46a-d) for displaying alignment information, and a control and evaluation unit (40) configured to use the position sensor (44) to determine the sensor device's (10) alignment, to compare the alignment with a desired alignment, and to display a comparison result using the display unit (46a-d), wherein the display unit (46a-d) comprises at least three light sources (46a-d) at positions distributed over the housing (48a-b), each light source (46a-d) being configured to assume a first display state for a correct alignment and a second display state for an alignment that is not yet correct, with the control and evaluation unit (40) further being configured to display the comparison result as display states of the light sources (46a-d).

2. The sensor device (10) according to claim 1,
the sensor device (10) being configured as at least one of a laser scanner and a radar sensor.

3. The sensor device (10) according to claim 1,
wherein the display states relate to an axis represented by the position of the displaying light source (46a-d).

4. The sensor device (10) according to claim 1,
wherein the light sources (46a-d) are configured to assume three display states, and wherein the control and evaluation unit (40) is configured to display, at a light source (46a-d), the second display state when the alignment is too low and a third display state when the alignment is too high.

5. The sensor device (10) according to claim 1,
wherein the light sources (46a-d) are configured to assume display states as different colors.

6. The sensor device (10) according to claim 1,
wherein the light sources (46a-d) are configured as multicolor LEDs.

7. The sensor device (10) according to claim 1,
wherein the housing (48a-b) comprises a quadrangular cross-sectional area and the light sources (46a-d) are arranged in corners.

8. The sensor device (10) according to claim 7,
wherein four light sources (46a-d) are arranged in four corners.

9. The sensor device (10) according to claim 1,
comprising an interface (42) for specifying the desired alignment.

10. The sensor device (10) according to claim 1,
which is configured as a laser scanner having at least one scanning plane (50) and at least one light transmitter (22) for transmitting transmitted light (26), a movable deflection unit (12) for periodically deflecting the transmitted light (26), and a light receiver (32) for receiving remitted light (28) remitted by objects in the scanning plane (50), the control and evaluation unit (40) being configured to measure distances on the basis of a light time of flight of the transmitted light and the remitted light (26, 28).

11. The sensor device (10) according to claim 10,
wherein the position sensor (44) is calibrated with respect to a scanning plane (50).

12. An alignment method for a sensor (10), wherein an actual alignment of the sensor (10) is determined by means of a position sensor (44), the actual alignment is compared with a desired alignment, and a comparison result is displayed, wherein the comparison result is displayed by three light sources (46a-d) arranged at positions distributed over the sensor (10), each of the light sources assuming a first display state for a correct position or a second display state for an alignment that is not yet correct.

13. The alignment method according to claim 12,
wherein the sensor (10) comprises a housing (48a-b), the position sensor (44), a display unit (46a-d) having the light sources (46a-b), and a control and evaluation unit (40) configured to execute the method steps.

14. The alignment method according to claim 12,
wherein the sensor (10) is configured as a laser scanner having at least one scanning plane (50) that is periodically scanned by a scanning beam (26, 28), wherein the position sensor (44) is calibrated in advance with respect to the scanning plane (50) by guiding the scanning beam (26, 28) to a cooperative target and taking an image of the target and evaluating the image to determine the alignment of the scanning plane (50).

15. The alignment method according to claim 14,
wherein the image is taken with an IR camera.
